(19) United States
(12) Patent Application Publication
(10) Pub. No.: US 2002/0146541 A1
(43) Pub. Date: Oct. 10, 2002

(54) Sandwich structure between metallic and non-metallic materials

(76) Inventor: Reinhard Fried, Nussbaumen (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/107,050

(22) Filed: Mar. 28, 2002

(30) Foreign Application Priority Data
Apr. 6, 2001 (DE) 101 17 127.7

(51) Int. Cl. B32B 3/00

(52) U.S. Cl. 428/172

(57) ABSTRACT

The invention relates to a sandwich structure (1) between metallic and non-metallic materials, in which a bond layer (3) is arranged on one surface (10) of the metallic material, which forms a base body (2), to which bond layer the non-metallic material (5), preferably ceramic material, is applied as a covering layer, and the bond layer (3) comprises separate, adjacently arranged spherical rivets (4) or mushroom-shaped rivets (4) which have a web (8) and a head (9). According to the invention, the rivets (4) are cast at the same time as the base body (2). They form individual islands of metal, around which there is a continuous ceramic network, which has a positive influence on the properties of the sandwich structure.

### TECHNICAL FIELD

The invention relates to a cast sandwich structure between metallic and non-metallic materials, in particular for the construction of gas and steam turbines, and to a process for producing this sandwich structure.

### PRIOR ART

The structure of sandwich structures comprising metallic and non-metallic materials, such as for example the coating of metallic components used in the construction of gas and steam turbines with ceramic thermal barrier coatings, forms part of the generally known prior art.

A bond layer with a surface which is as rough as possible is sprayed onto a metallic surface of a base body, for example by means of plasma spraying or flame spraying. The roughness of the surface is used for the positively locking anchoring of the thermal barrier coating comprising a non-metallic material which is likewise plasma-sprayed or flame-sprayed onto this surface. On account of the very different coefficients of thermal expansion between metals and non-metallic materials, such as ceramics, these joins are usually only suitable up to a layer thickness of <500 μm.

Components which are provided with thermal barrier coatings are used, for example, in combustion chambers or as gas turbine blades or vanes.

Known processes for producing holding structures for ceramic thermal barrier coatings (TBC) include, in addition to the plasma spraying or flame spraying of bond layers described above, the processes of cavity sinking, laser/water jet/electron beam modeling, soldering and sintering of particles (DE 195 45 025 A1) or the production of a substantially network-like skeleton structure, which is cast at the same time, on the surface of the base body (EP 0 935 009 A1).

If the sandwich structure is sprayed with highly porous ceramic, it is possible to achieve layer thicknesses of up to 1.5 mm. However, these ceramics are extremely sensitive to impacts from foreign bodies, so that the service life of sandwich structures of this type is only very short, and therefore the structures often have to be exchanged or repaired.

In order, for example, to considerably reduce the consumption of cooling air in a gas turbine and thereby to increase efficiency, there is a need for a considerably more effective thermal barrier than that which is known from the prior art, for example from the document DE 195 45 025 A1.

This more effective thermal barrier can be achieved by the application of relatively thick TBC layers. However, to ensure sufficient adhesion of these thick layers to a base body, it is necessary for very coarse holding structures to be produced on the surface of the base body.

The applicant is aware of a process (DE 100 57 187.5) in which spherical or mushroom-shaped coarse holding structures (anchor points, also known as rivets) are produced on a surface by a welding process, in particular an arc welding process. In this case, to produce these holding structures, a preferably endless welding wire is melted down, the melted welding wire itself forming the specially shaped anchor points.

Welded-on coarse anchor points of this type differ significantly from the integrally cast skeleton structures such as those which are known from EP 0 935 009 A1.

The integrally cast structure which is known from the document EP 0 935 009 A1 represents a continuous network, within which, after the coating, there are individual ceramic islands. By contrast, the welded structures have a continuous ceramic network with individual metal islands, which has beneficial effects on the properties of the layer. For example, in particular the lower thermal conduction, the smaller metal surface area which is exposed to the oxidation and the improved anchoring of the ceramic layer with the welded structures compared to the cast network-like structures should be mentioned.

### SUMMARY OF THE INVENTION

The invention attempts to avoid the abovementioned drawback of the known cast network-like structure. It is based on the object of providing a cast sandwich structure between metallic and non-metallic materials, in particular for the construction of gas and steam turbines, and a process for producing these sandwich structures, in which, on the one hand, a considerable layer thickness of a non-metallic material is applied to a metallic material in such a manner that it adheres stably and is insensitive to the action of impacts and, on the other hand, a lower thermal conduction and a smaller metal surface area which is exposed to the oxidation compared to the known prior art are achieved.

According to the invention, this is achieved, in a sandwich structure between metallic and non-metallic materials, in which a bond layer is arranged on one surface of the metallic material, which forms a base body, to which bond layer the non-metallic material is applied as a covering layer, and the bond layer comprises separate, adjacently arranged spherical or mushroom-shaped rivets which have a web and a head, by a holding structure comprising said rivets, which is cast on the surface of the base body at the same time.

According to the invention, in a process for producing the sandwich structures in accordance with the preamble of patent claim 8, this is achieved by the fact that the rivets are cast together with the base body at the same time by means of a known wax model casting process.

In this context, it is advantageous that the sandwich structures according to the invention have a continuous non-metallic network, in particular ceramic network, with individual metal islands, which has a positive effect on the properties of the layer. For example, in particular the lower heat conduction, the smaller metal surface area which is exposed to oxidation and the improved anchoring of the ceramic layer in the cast holding structures according to the invention compared to the cast network-like or grid-like holding structures which are known from the prior art can be mentioned.

Advantageous configurations of the sandwich structures are described in subclaims 2 to 7.

### BRIEF DESCRIPTION OF THE DRAWING

An exemplary embodiment of the invention in the individual process steps is illustrated in the drawing on the basis of a thermal barrier plate for a gas turbine combustion chamber.

In the drawing:

FIG. 1 shows a section through an injection-molded wax plate with separate injection-molded wax spheres (first process step);

FIG. 2 shows a section through the wax plate with the mounted (melted-on) wax spheres (second process step);

FIG. 3 shows a section through a tundish with wax model (third process step);

FIG. 4 shows a section through the tundish once the wax has been melted out (fourth process step);

FIG. 5 shows a section through the tundish with cast-in metal (fifth process step);

FIG. 6 shows a section through the demolded casting with the sprue funnel having been detached (sixth process step);

FIG. 7 shows a section through the finished, TBC-coated thermal barrier plate with mushroom-shaped rivets (seventh process step); and

FIG. 8 shows a section through a finished TBC-coated thermal barrier plate with spherical rivets.

Only the features which are essential to the invention are illustrated in the figures.

### WAYS OF CARRYING OUT THE INVENTION

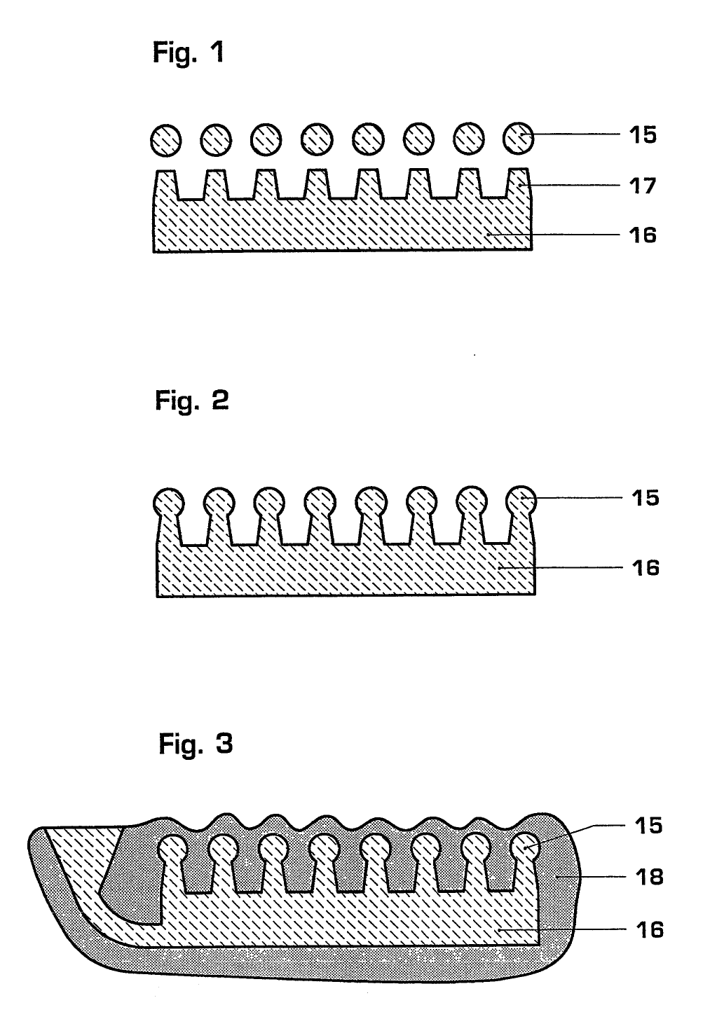

The invention is explained in more detail below with reference to exemplary embodiments and FIGS. 1 to 8.

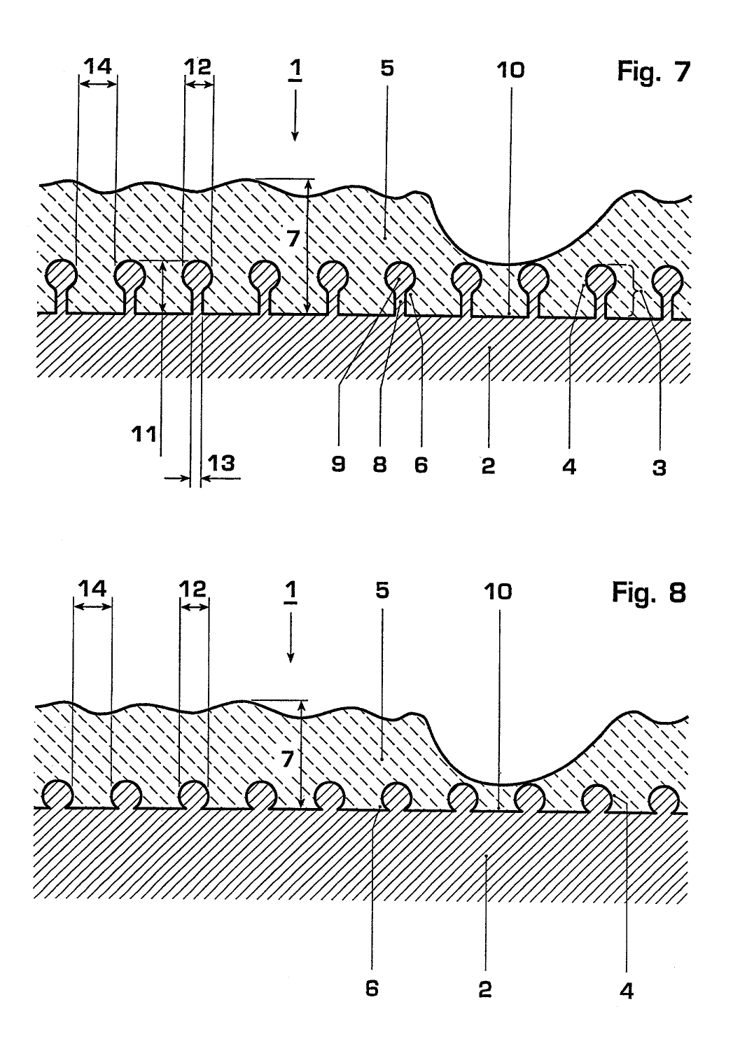

FIGS. 1 to 7 diagrammatically depict the individual steps of the process according to the invention, with the sandwich structure according to the invention with mushroom-shaped rivets being illustrated by way of example in FIG. 7. FIG. 8 illustrates a further design variant of the invention, with spherical rivets.

For sandwich structures 1 of this type, as can be seen in particular from FIGS. 7 and 8, a bond layer 3 is applied to the surface of a metallic base body 2, which bond layer is formed from individual anchor points, in this case known as rivets 4, and to which bond layer a non-metallic material 5 is then applied. A characteristic feature of the present invention is that the holding structure (bond layer 3) is cast on the surface 10 of the base body 2 together with the base body 2 at the same time and comprises said rivets 4. Examples of materials which can be used for the base body 2 and the rivets 4 are IN 738, IN 939, MA 6000, PM 2000, CMSX-4 and MARM 247.

The prefabricated rivets 4 either have a mushroom-shaped structure, in which case they have a web 8 and a head 9 (FIG. 7) or are of spherical design (FIG. 8). The shape of the rivets 4 may vary, i.e. they may have different web heights and different web or head diameters.

It is advantageous if the mushroom-shaped rivets 4 which are cast at the same time have a head diameter 12 of approx. 0.8 mm to 3 mm and a web diameter 13 of approx. 0.5 mm to 2 mm, and a height 11 of approx. 1 mm to 10 mm. Then, there are very good possibilities for anchoring the non-metallic layer which is subsequently to be applied.

The spherical rivets 4 which are cast at the same time preferably have a diameter 12 of approx. 0.5 mm to 3 mm, since there are then once again good possibilities for anchoring the non-metallic material 5 which is to be applied.

The special shape of the rivets 4 results in a suitable surface roughness being created, with the result that the non-metallic material 5, which is to be applied in the liquid state, produces a positively locking join to the metallic base body 2, i.e. corresponding undercuts 6, in the form of free spaces between the rivets 4 and the base body 2, are formed by the rivets 4, into which undercuts the non-metallic material 5 flows or becomes hooked, thus producing a secure join between the non-metallic material 5 and the metallic material, in particular the base body 2. The non-metallic material 5, for example ceramic, can be applied using known processes, such as plasma spraying or flame spraying.

It is essential for the production of a sandwich structure 1 of this type that a defined surface roughness with sufficient undercuts 6 be produced, so that a high strength and sufficient coating thickness 7 for the non-metallic material 5 can be produced. A considerable coating thickness 7 has the effect, for example, of considerably reducing the consumption of cooling air in a gas turbine, so that the efficiency of the gas turbine is considerably increased. However, to ensure that a considerable coating thickness 7 can be created, it is necessary to form a significantly larger holding structure or more coarse bond layer 3 than is known from the prior art by the application of soldering pastes with additional elements or the like. Therefore, it can be stated that, depending on the shape and size of the rivets 4, a suitable coating thickness 7 for the non-metallic material 5 can be applied to the base body 2.

In sandwich structures 1 of this type, as are used, for example, in gas or steam turbines, the non-metallic material 5 applied should be sufficiently able to withstand impacts from foreign bodies without the non-metallic material 5 being separated or detached from the metallic material, i.e. from the base body 2. However, if the non-metallic material 5 should nevertheless become detached as a result of an impact from a foreign body on account of the force being excessive, it should be ensured that the surface of the sandwich structure 1 is only slightly disturbed. The special production of the bond layer 3, in particular the special design of the mushroom-shaped rivets 4, ensures that, in the event of an impact from a foreign body, only the material which projects beyond the rivets 4 is detached, whereas the non-metallic material 5 between the rivets 4 is not separated from the sandwich structure 1. As a result, only small points of attack on the base body 2 above the rivets 4 are formed.

This is achieved to the extent that, on account of the specially defined design of the rivets 4 with web 8 and head 9, large-area undercuts 6 and a defined number of rivets 4 can be formed on a predetermined area, so that the non-metallic material 5, which embeds the rivets 4, produces a very secure join thereto, and therefore this material can no longer be separated from the base body 2 between the individual rivets 4. The right-hand part of FIG. 7 diagrammatically depicts an illustration of this type after an impact from a foreign body during which part of the non-metallic material 5 has been detached. It can be seen from this illustration that, in the event of an impact from a foreign body, although the non-metallic material 5 above the rivets 4 has been detached, it remains securely in place between the rivets 4 and therefore only small amounts of heat can be transferred to the base body 2 via the rivets 4, so that undesired destruction of the sandwich structure 1 in the region of the impact from the foreign body can be prevented.

It is advantageous if the coating thickness 7 for the non-metallic material 5, which is, for example, ceramic material, preferably yttrium-stabilized zirconia, is between 1 mm and 20 mm, since this enables the thermal barrier coating to withstand even very high temperature differences without problems.

The distance 14 between two adjacent heads 9 of the rivets 4 should preferably approx. 1 to 5 times the diameter 12 of the head 9. Larger distances are also conceivable.

A thermal barrier plate for a gas turbine and a process for its production are described as a specific exemplary embodiment with reference to FIGS. 1 to 7. The plates are produced in the following steps:

First of all, in a known way, a wax model is produced. As shown in FIG. 1, for this purpose individual wax spheres 15 and a wax plate 16 with webs 17 are cast separately.

Then, as shown in FIG. 2, in a second process step the wax spheres 15 are melted onto the free ends of the webs 17.

In a third process step (FIG. 3), a tundish 18 is placed around the wax model, which also has a sprue funnel 19.

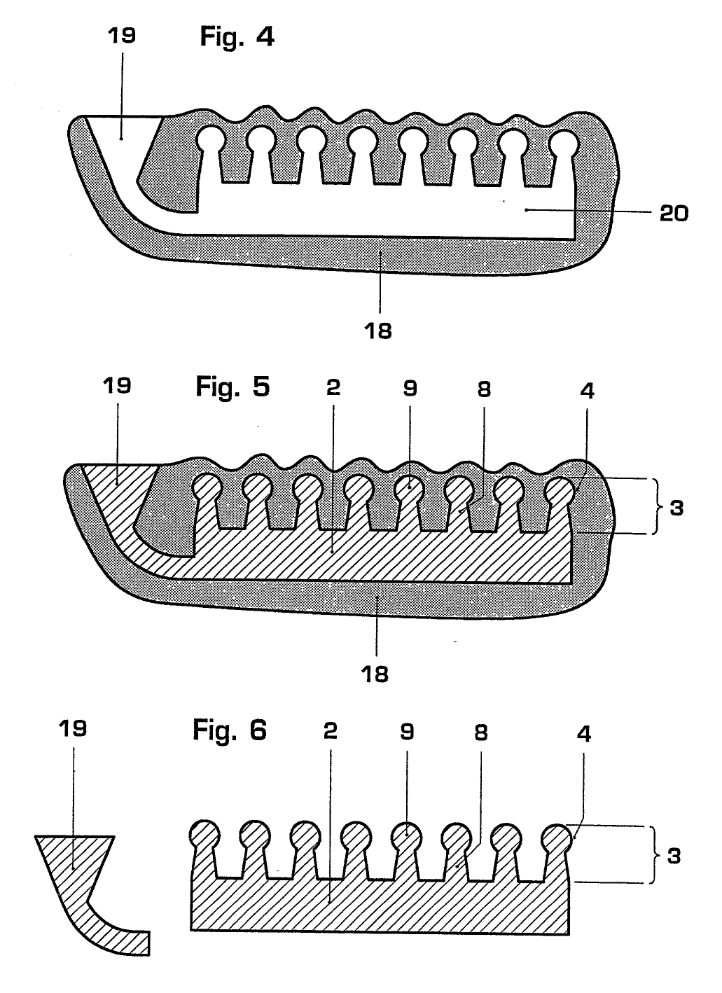

Then, the wax is melted out, so that a hollow space 20, which corresponds to the part which is to be cast, is formed in the tundish 18 (FIG. 4).

The hollow space 20 is filled with the liquid metal, in this case IN 939 of the following chemical composition: 22.5% Cr, 19% Co, 2% W, 1% Nb, 1.4% Ta, 3.7% Ti, 1.9% Al, 0.1% Zr, 0.01% B, 0.15% C, remainder Ni (FIG. 5).

After the material has solidified, the casting is demolded and the sprue funnel 19 is sawn off (FIG. 7). Therefore, on its surface 10, the base plate 2 has mushroom-shaped rivets 4 which are cast on at the same time and form the bond layer 3 for the non-metallic material 5 which is to be applied. The rivets 4 have a diameter 12 of the head 9 of 1.2 mm, a diameter 13 of the web 8 of 0.6 mm and a web height of 1 mm, corresponding to a total height 11 of the rivets 4 of 2.2 mm. The distance 14 between two adjacent heads 9 of the rivets 4 is approximately 1.5 mm.

Finally, this cast metallic base plate 2 together with the integrally cast rivets 4 is coated with TBC by means of air plasma spraying. The TBC layer consists of yttrium-stabilized zirconia of the following chemical composition: 2.5% HfO₂, 7-9% Y₂O₃, <3% of other elements, remainder ZrO. The layer thickness 7 of the TBC layer is approx. 4.5 to 5 mm.

A thermal barrier plate which had been coated in this way was subjected to a thermal shock test from 1200° C. to room temperature. A flame was used for heating (1200° C.) on the TBC side, while on the base body side compressed air was used for cooling (900° C). 850 thermal cycles were completed without any flaking of the TBC layer. This demonstrates the excellent anchoring possibilities of the ceramic material 5 in the bond layer 3 comprising the rivets 4 cast together with the base body 2 at the same time.

Naturally, spherical rivets 4 may be used as well as the mushroom-shaped rivets 4 cast on at the same time which have been described (FIG. 8).

### List of Reference Symbols

1. Sandwich structure

2. Metallic base body

3. Bond layer

4. Rivet (anchor point)

5. Non-metallic material

6. Undercut

7. Coating thickness of 5

8. Web of 4

9. Head of 4

10. Surface of 2

11. Height of 4

12. Diameter of 9

13. Diameter of 8

14. Distance between two adjacent heads of 4

15. Wax sphere

16. Wax plate

17. Webs of 16

18. Tundish

19. Sprue funnel

20. Hollow space in 18

What is claimed is:

1. A sandwich structure (1) between metallic and non-metallic materials, in which a bond layer (3) is arranged on one surface (10) of the metallic material, which forms a base body (2), to which bond layer the non-metallic material (5) is applied as a covering layer, and the bond layer (3) comprises separate, adjacently arranged spherical rivets (4) or mushroom-shaped rivets (4) which have a web (8) and a head (9), characterized by a holding structure comprising said rivets (4), which is cast on the surface (10) of the base body (2) at the same time.

2. The sandwich structure (1) as claimed in claim 1, characterized in that the mushroom-shaped rivets (4) which are cast at the same time have a diameter (12) of the head (9) of approx. 0.8 mm to 3 mm and a diameter (13) of the web (9) of approx. 0.5 mm to 2 mm.

3. The sandwich structure (1) as claimed in claim 1, characterized in that the mushroom-shaped rivets (4) which are cast at the same time have a height (11) of approx. 1 mm to 10 mm.

4. The sandwich structure (1) as claimed in claim 1, characterized in that the spherical rivets (4) which are cast at the same time have a diameter (12) of approx. 0.5 mm to 3 mm.

5. The sandwich structure (1) as claimed in claim 1, characterized in that the distance (14) between two adjacent heads (9) of the rivets (4) is approx. 1 to 5 times the diameter (12) of the head (9).

6. The sandwich structure (1) as claimed in one of claims 1 to 5, characterized in that the metallic base body (2) with the integrally cast rivets (4) preferably consists of IN 738, IN 939, MA 6000, PM 2000, CMSX-4 and MARM 247, and the non-metallic material (5) is ceramic material, preferably yttrium-stabilized zirconia.

7. The sandwich structure (1) as claimed in claim 1, characterized in that the coating thickness (7) for the non-metallic material (5) is between 1 mm and 20 mm.

8. A process for producing sandwich structures (1) between metallic and non-metallic materials as claimed in one of claims 1 to 7, in which a bond layer (3) is applied to a surface (10) of a metallic base body (2), and then a non-metallic material (5) is applied to the bond layer, and in which the bond layer (3) is produced from separate, adjacently arranged spherical rivets (4) or rivets (4) which have a mushroom-like shape with a web (8) and a head (9), characterized in that the rivets (4) are cast together with the base body (2) at the same time by means of known wax model casting processes.
